(19) United States
(12) Patent Application Publication
(10) Pub. No.: US 2012/0188926 A1
(43) Pub. Date: Jul. 26, 2012

(54) METHOD AND APPARATUS FOR FEEDING BACK ACK/NACK INFORMATION

(75) Inventors: Yingyang Li, Beijing (CN); Chengjun Sun, Beijing (CN); Xiaoqiang Li, Beijing (CN)

(73) Assignee: SAMSUNG ELECTRONICS CO., LTD., Suwon-si (KR)

(21) Appl. No.: 13/355,378

(22) Filed: Jan. 20, 2012

(30) Foreign Application Priority Data
Jan. 20, 2011 (CN) 201110035031.7
Nov. 4, 2011 (CN) 201110352736.1

(51) Int. Cl. H04W 74/02; H04W 52/02

(52) U.S. Cl. 370/311; 370/329

(57) ABSTRACT

A method for feeding Acknowledgement/Negative Acknowledgement (ACK/NACK) information by a User Equipment (UE) in a wireless communication system includes: the UE configured to receive Physical Downlink Control Channel (PDCCH) information from a base station (BS). The UE also receives downlink data from the BS based on the PDCCH information. The UE generates an ACK/NACK feedback information corresponding to the downlink data. Thereafter, the UE determines a feedback status of the UE from among a plurality of feedback statuses according to a number of consecutive ACKs starting from a first data sub-frame in a binding window of the ACK/NACK feedback information. Further, the UE feeds back information on the determined feedback status to the BS.

### CROSS-REFERENCE TO RELATED APPLICATION(S) AND CLAIM OF PRIORITY

The present application is related to and claims the benefit under 35 U.S.C. §119(a) of a Chinese patent application filed in the Chinese Patent Office on Jan. 20, 2011 and assigned Serial No. 201110035031.7, and on Nov. 4, 2011 and assigned Serial No. 20110352736.1, the entire disclosures of which are hereby incorporated by reference.

### TECHNICAL FIELD OF THE INVENTION

The present invention relates to wireless communication technologies. More particularly, the present invention relates to a method and an apparatus for feeding back Acknowledgement/Negative Acknowledgement (ACK/NACK) information.

### BACKGROUND OF THE INVENTION

A long term evolution (LTE) system transmits data based on Hybrid ARQ (HARO), that is, a data receiver transmits acknowledgement (ACK) or Negative Acknowledge (NACK) based on whether the data is corrected received. Scheduling of dynamic downlink data transmissions is implemented via a Physical Downlink Control Channel (PDCCH). For Semi-Permanent Scheduling (SPS) service, no PDCCH is required to be transmitted during initial transmission of downlink data, and the re-transmission of the downlink data is implemented via PDCCH scheduling.

In LTE TDD system, to enable the User Equipment (UE) to determine whether one or more PDCCH transmitted by a base station is lost, a technique called downlink Assignment Index (DAI) is provided. Specifically, DAI identifies PDCCH of a downlink sub-frame is which PDCCH in the current binding window. Here, DAI field is of 2 bits, and can indicate 4 values, so that there is no confusion when the current binding window size M is 1, 2, 3, 4. For an uplink-Downlink Configuration 5 of a TDD, M is equal to 9, and it is needed to reuse four values; here, because the value of DAI is counted from 1, the number of current PDCCH is a, then the value of DAI can be obtained via operating mode 4, that is.

In LTE-Advanced (LTE-A) system, in order to support higher data rate, a carrier Aggregation (CA) technique is introduced, that is, to aggregate two or more Component Carriers (CC) to obtain larger working bandwidth. For example, five 20 MHz CCs can be aggregated to support a 100 MHz bandwidth. Based on CA, the base station transmits downlink data to the same UE through two or more CCs. Accordingly, UE also needs to feed back two or more ACK/NACK information corresponding to the downlink data of the CC. Here, each CC is called as a cell.

According to the current discussion of the results of LTE-A, the technique based on the channel selection can support at most 4-bit ACK/NACK transmission. In LTE-FDD, the channel selection method in fact only supports two cells, and each cell feeds back at most 2-bit ACK/NACK information. Taking 4-bit table as an example, the main cell (or Pcell) and sub-cell (or Scell) with cross-cell scheduling of obtain two ACK/NACK channel according to the scheduling downlink data. For example, the smallest CCE index of PDCCH is n, then, CCE index n and n+1 can be mapped to obtain two ACK/NACK channels according to LTE method. With respect to Scell without cross-cell scheduling, two ACK/NACK channels are configured by higher-layer, and an ACK/NACK resource indication (ARI) can be used to increase the allocation flexibility.

According to the current discussion of the results, the FDD system adopts the 4-bit table shown in FIG. 1. Here, the ACK/NACK channels 1, 2 correspond to two ACK/NACK bits of the Pcell in turn; the ACK/NACK channels 3, 4 correspond to two ACK/NACK bits of the Scell in turn. In the table of FIG. 1, the nature that two ACK/NACK channels of the same cell always exist or not exist at the same time, is adopted to optimize performance. FIG. 2 shows another 4-bit table. Here, only when some ACK/NACK information is ACK, the corresponding ACK/NACK channel is selected to transmit. The only exception is that, to take full advantage of M (M equals to 2, 3 or 4) channel feedback capacity, one QPSK constellation point of the first ACK/NACK channel can be used to indicate when the first ACK/NACK information is NACK while other ACK/NACK information are NACK or Discontinuous Transmission (DTX). The method of FIG. 2 can be applied to 4 ACK/NACK bits and their corresponding ACK/NACK channels which are all independent existence.

According to the current LTE-A standard, the LTE-A TDD system also adopts the 4-bit mapping table shown in FIG. 2.

In the present discussion, one method for feeding back ACK/NACK information based on channel selection in the LTE-A TDD system is based on the DAI design of the above mentioned LTE, the ACK/NACK information corresponding to each PDCCH which is needed to feed back ACK/NACK information, is first sorted in an ascending order of a DAI; if there is SPS service, then its ACK/NACK information is sorted in the first; next, number of the consecutive ACK starting from the first ACK/NACK information is fed back to each cell.

Specifically, when the binding window size M equals to 3, the number of consecutive ACKs fed back to each cell can be 0, 1, 2, or 3, of which each can be mapped to 2 bits, for the example shown in table 1. When the binding window size M equals to 4, the number of consecutive ACKs fed back to each cell can be 0, 1, 2, 3, or 4, which can be processed into 4 statuses through overlap mapping method, thus can be mapped to 2 bits, one method is shown in table 2. In the tables 1-2, N denotes NACK, A denotes ACK, D denotes DTX, Symbol “/” denotes “or”.

TABLE 1

| At most 3 ACK/NACK | |
|---|---|
| information in binding window | Mapping 2 bits |
| A, A, A | A, A |
| A, A, N/D | N/D, A |
| A, N/D, any | A, N/D |
| N/D, any, any | N/D, N/D |

TABLE 2

| At most 4 ACK/NACK information in | |
|---|---|
| binding window | mapping status |
| A, A, A, N/D | A, A |
| A, A, N/D, any | N, A |
| A, A, A, A | A, N |
| Or, A, D, D, D | |
| N, any, any, any | N, N |
| Or, A, N/D, any, any except for A, | |
| D, D, D | |
| D, any, any, any | D, D |

In this way, according to the state mapping in tables 1-2, two bit information of each of the Pcell and Scell can be obtained, respectively, thus, the mapping table of FIG. 1 or FIG. 2 can be used to feed back ACK/NACK information according to channel selection method.

However, the above described methods only provide solutions when M equals to 3 or 4; but for an uplink-Downlink Configuration 5 of a TDD, a mapping method is needed to feed back ACK/NACK information of two cells.

### SUMMARY OF THE INVENTION

To address the above-discussed deficiencies of the prior art, it is a primary object to provide at least the advantages described below. Accordingly, an aspect of the present disclosure is to provide two methods of feeding ACK/NACK information, which can increase downlink data throughput.

In accordance with an aspect of the present disclosure, a method for feeding back Acknowledgement/Negative Acknowledgement (ACK/NACK) information by a User Equipment (UE) in a wireless communication system includes: receiving Physical Downlink Control Channel (PDCCH) information from a base station (BS), and receiving downlink data from the BS based on the PDCCH information; generating ACK/NACK feedback information corresponding to the downlink data; determining a feedback status of the UE from among a plurality of feedback statuses according to a number of consecutive ACKs starting from a first data sub-frame in a binding window of the ACK/NACK feedback information; and feeding back information on the determined feedback status to the BS.

In accordance with another aspect of the present disclosure, a method for feeding back Acknowledgement/Negative Acknowledgement (ACK/NACK) information by a User Equipment (UE) in a wireless communication system includes: receiving Physical Downlink Control Channel (PDCCH) information from a base station (BS) in each of a main cell and a sub cell, and receiving downlink data from the BS in each of the main cell and the sub cell; generating ACK/NACK feedback information corresponding to the main cell and the sub cell; determining a feedback status for each of the main cell and the sub cell from a plurality of feedback statuses according to the ACK/NACK feedback information of the main cell and the sub cell in a binding window; and feeding back information on the feedback status for each of the main cell and the sub cell to the BS in each of the main cell and the sub cell.

In accordance with another aspect of the present disclosure, a User Equipment (UE) for feeding back Acknowledgement/Negative Acknowledgement (ACK/NACK) information in a wireless communication system, the UE includes: a receiver that can receive Physical Downlink Control Channel (PDCCH) information from a base station (BS), and receive downlink data from the BS based on the PDCCH information; a controller that can generate ACK/NACK feedback information corresponding to the downlink data, and determine a feedback status of the UE from among plurality of feedback statuses, according to a number of consecutive ACKs starting from a first data sub-frame in a binding window of the ACK/NACK feedback information; and a transmitter that can feed back information on the determined feedback status to the BS.

In accordance with another aspect of the present disclosure, a User Equipment (UE) for feeding back Acknowledgement/Negative Acknowledgement (ACK/NACK) information in a wireless communication system, the UE includes: a receiver that can receive Physical Downlink Control Channel (PDCCH) information from a base station (BS) in each of a main cell and a sub cell, and receive downlink data from the BS in each of the main cell and the sub cell; a controller that can generate ACK/NACK feedback information corresponding to the main cell and the sub cell, and determine a feedback status for each of the main cell and the sub cell from a plurality of feedback statuses according to the ACK/NACK feedback information of the main cell and the sub cell in a binding window; and a transmitter that can feed back information on the feedback status for each of the main cell and the sub cell to the BS in each of the main cell and the sub cell.

Using the method and the apparatus of the present disclosure, provides a method and an apparatus in the uplink-Downlink Configuration 5 of the TDD based on the channel selection method for transmitting ACK/NACK information of two cell, which can increase downlink data throughput.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a mapping table of LTE-A FDD according to the present disclosure;

FIG. 2 illustrates another mapping table according to the present disclosure;

FIG. 3 illustrates a method for feeding ACK/NACK information according to an exemplary embodiment of the disclosure; and

FIG. 4 illustrates a structure of a UE according to an exemplary embodiment of the present disclosure.

Throughout the drawings, it should be noted that like reference numbers are used to depict the same or similar elements, features, and structures.

### DETAILED DESCRIPTION OF THE INVENTION

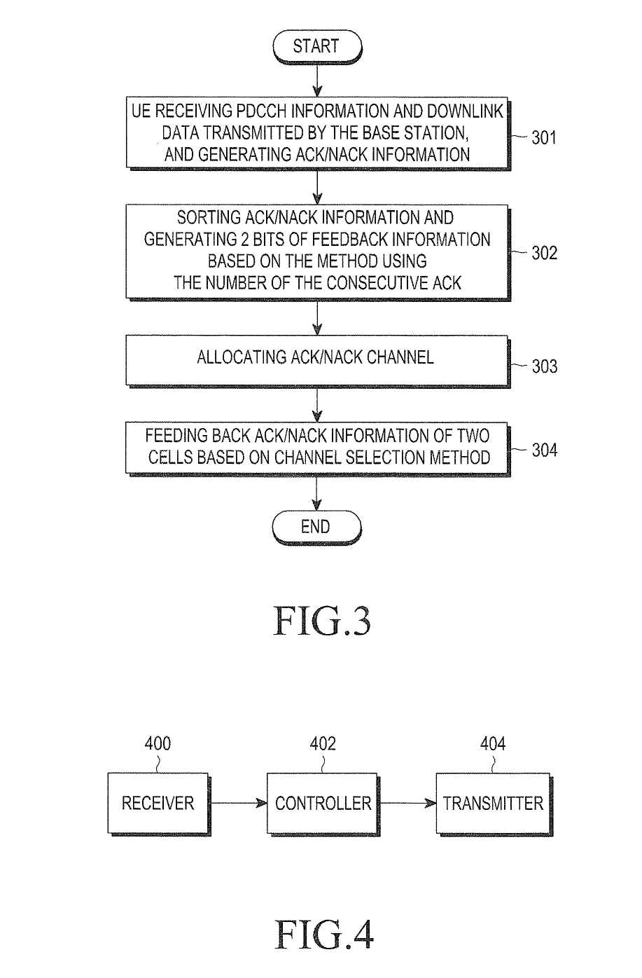

FIGS. 3 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of exemplary embodiments of the present disclosure is provided for illustration purpose only and not for the purpose of limiting the disclosure as defined by the appended claims and their equivalents.

The present invention will be described in further detail hereinafter with reference to accompanying drawings and embodiments to make the objective, technical solution and merits therein clearer.

Exemplary embodiments of the present disclosure provide a method and an apparatus of feeding Acknowledgement/Negative acknowledgement (ACK/NACK) information, includes: UE in the uplink-Downlink Configuration 5 of the TDD receiving PDCCH information and downlink data transmitted by a base station, and generating corresponding ACK/NACK feedback information; determining a feedback status from 4 feedback statuses according to number of consecutive ACKs starting from a first data sub-frame in a current binding window of the ACK/NACK feedback information, and denoting the determined feedback status using 2 bits of status information; and feeding back the status information by the UE based on channel selection method.

Specifically, the above mentioned 4 feedback statuses can be:

The feedback is denoted by Fₚ when the number of consecutive ACKs is p;

When p=1, 2, . . . , M−3, each Fₚ can be separated into two subset feedbacks, and M denotes a length of the binding window; the first subset feedback denotes that the front p ACK/NACK information is ACK; the other M-p ACK/NACK information is DTX, which is denoted by F_{p,DTX}; the second subset feedback denotes other statuses in the feedback Fₚ except for subset feedback F_{p,DTX} and can be denoted by F_{p,NACK};

The first feedback status of the 4 feedback statuses is a set of the F₀ and F_{p,NACK}, p=1,2, . . . , M−3;

The second, third and forth feedback statuses of the 4 feedback statuses are respectively:

$$\begin{matrix}{G}_{3 m + 1} , m = 0 , 1 , 2 , … , ⌊ ( M - 1 ) / 3 ⌋ & [ Eqn . 1 ] \\ {G}_{3 m + 2} , m = 0 , 1 , 2 , … , ⌊ ( M - 2 ) / 3 ⌋ & [ Eqn . 2 ] \\ {G}_{3 m + 3} , m = 0 , 1 , 2 , … , ⌊ ( M - 3 ) / 3 ⌋ & [ Eqn . 3 ] \\ wherein , {G}_{p} = \{ \begin{matrix}{F}_{p , DTX} , p = 1 , 2 , … , M - 3 \\ {F}_{p} , p = M - 2 , M - 1 , M\end{matrix} & [ Eqn . 4 ]\end{matrix}$$

The manner using 2 bits of status information to denote the feedback status are:

The first feedback status is denoted by using two bits of status information which are NACK/DTX;

The second feedback status is denoted by using two bits of status information which are ACK and NACK/DTX in turn;

The third feedback status is denoted by using two bits of status information which are NACK/DTX and ACK in turn;

The forth feedback status is denoted by using two bits of status information which are ACK.

Further, when the base station transmits PDCCH or SPS service business data which are needed to feed back ACK/NACK information only through a portion of the sub-frames, UE receives the portion of the sub-frames of the PDCCH information transmitted by the base station, and generates corresponding ACK/NACK feedback information, and determines a feedback status according to the ACK/NACK feedback information.

One uplink sub-frame is required to feed back M ACK/NACK feedback information of multiple downlink sub-frames, here M is larger than 4. As shown in FIG. 3, a method of the disclosure for feeding ACK/NACK information of two cell based on channel selection when M is larger than 4, is described below.

Block 301: UE first receives PDCCH information and downlink data transmitted by the base station. When the base station adopts MIMP for transmitting downlink data, 2 bits of ACK/NACK information of one sub-frame is first bundled to 1 bit via spatial bundling. Here, the spatial bundling means that only when the two bits ACK/NACK are ACK, they are bundled as ACK, otherwise, NACK is obtained.

Block: 302: the ACK/NACK information corresponding to each PDCCH which is needed to feed back ACK/NACK information, is sorted in an ascending order of a DAI; if there is SPS service, then its ACK/NACK information is sorted in the first; next, the consecutive ACK starting from the first ACK/NACK information is counted. In this way, the number of consecutive ACKs can have M+1 possible values, which can be respectively denoted by feedback information Fₖ, k=0, 1, 2, . . . , M. Fₖ denotes that the front k ACK/NACK information is ACK; if there is k+1 ACK/NACK information, then it is not ACK; if there is other ACK/NACK information, they can be any one of ACK, NACK, DTX.

Here, each Fₚ, of which the number of consecutive ACK is p=1, 2, . . . , M−3, can be separated into two subset feedbacks, the first subset feedback denotes that the front p ACK/NACK information is ACK; the other M-p ACK/NACK information is DTX, which is denoted by F_{p,DTX} ;the second subset feedback denotes other statuses in the feedback Fₚ except for subset feedback F_{p,DTX} and can be denoted by F_{p,NACK}.

F₀ denotes the number of consecutive ACK is 0, and is also can be separated into two subsets. For example, the first subset feedback denotes that the first ACK/NACK information is NACK; if there is other ACK/NACK information, that can be any one of ACK, NACK, DTX, and can be denoted as F_{0,NACK}; the second subset feedback denotes that the first ACK/NACK information is DTX, if there is other ACK/NACK information, that can be any one of ACK, NACK, DTX, and can be denoted as F_{0,DTX}.

Thereafter, the feedback information of the above mentioned M+1 possible numbers of consecutive ACK is mapped to 4 feedback statuses. F₀ and F_{p,NACK}, p=1, 2, . . . , M−3 can be bundled into one feedback status, and is mapped to NACK/DTX, NACK/DTX.

Specifically, F_{0,NACK} and F_{p,NACK}, p=1, 2, . . . , M−3 are together mapped to (NACK, NACK/DTX; F_{0,DTX} is mapped to (DTX, NACK/DTX. F_{p,DTX}, p=1, 2, . . . , M−3 F_{M-2} F_{M-1} and F_{M} are overlapped mapped to other 3 feedback statuses. Specifically,

$${G}_{p} = \{ \begin{matrix}{F}_{p , DTX} , p = 1 , 2 , … , M - 3 \\ {F}_{p} , p = M - 2 , M - 1 , M ,\end{matrix}$$

the feedback information G₃ₘ₊₁, m=0, 1, 2, . . . , └(M−1)/3┘ is overlapped mapped to (ACK, NACK/DTX), the feedback information G₃₊₂, m=0, 1, 2, . . . ,└(M−2)/3┘ is overlapped mapped to (NACK/DTX, ACK), the feedback information G₃ₘ₊₃, m=0, 1, 2, . . . , └(M−3)/3┘ is overlapped mapped to (ACK, ACK).

In this way, 2 bits information of the Pcell and cell can be respectively obtained. 2 bits of Pcell are mapped to front two bits in the mapping table; 2 bits of Scell are mapped to REAR two bits in the mapping table.

Block 303: Thereafter, ACK/NACK channel resource is allocated to the corresponding 4 bits of the above mentioned block 302. For example, one method for allocating ACK/NACK channels for Pcell is to determine two ACK/NACK channels respectively according to PDCCH with DAI value of 1 and PDCCH with DAI value of 2; for Scell with cross-carrier scheduling, it is to determine two ACK/NACK channels respectively according to PDCCH with DAI value of 1 and PDCCH with DAI value of 2; for Scell without cross-carrier scheduling, it is to configure a plurality of alternative ACK/NACK channels by higher-layer, and the ACK/NACK of PDCCH in scheduling Scell is used to indicate actually used two channels. The invention does not limit the methods for allocating ACK/NACK channel resource.

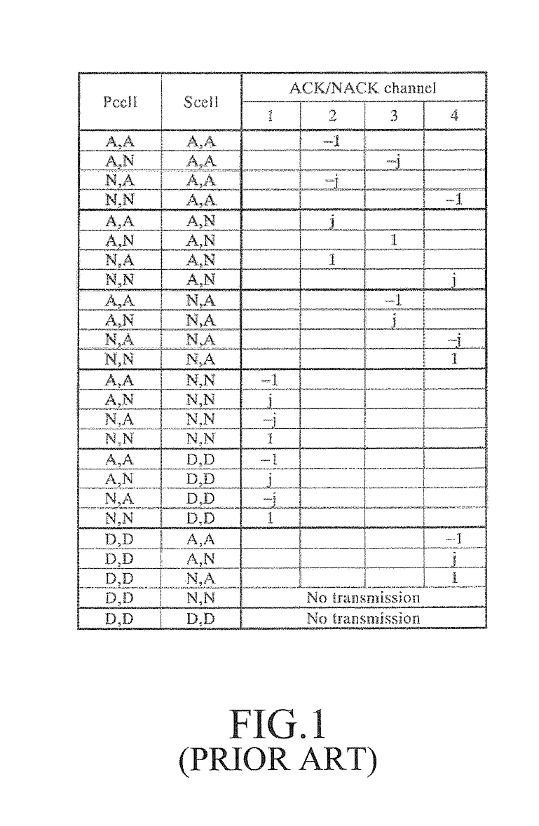

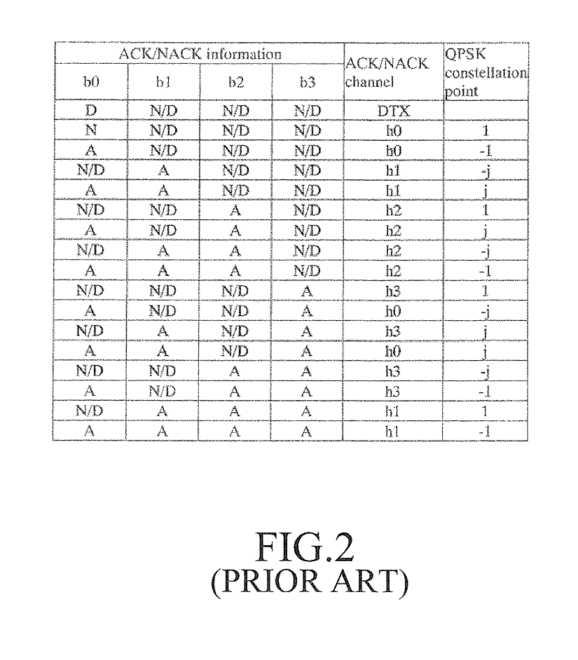

Block 304: finally, the status information is fed back based on channel selection method using mapping table of FIG. 1 or FIG. 2 or other mapping tables.

Two exemplary embodiments of the disclosure are described below.

### First Exemplary Embodiment

In the uplink-Downlink Configuration 5 of the TDD, because one uplink sub-frame is required to feed back ACK/NACK feedback information of at most 9 downlink sub-frames, that is, the binding window size is 9. At this time, 2 bit feedback information of each cell can be generated through the following methods. As shown in table 3,

The number of the consecutive ACK of the feedback information denoted by the 2 bits (A, A) can be 3, 6 or 9. When the number of the consecutive ACK equals to 3, the detailed feedback information is the front 3 ACK/NACK information is ACK, and other 6 ACK/NACK information is DTX, that is, “A, A, A, D, D, D, D, D, D”; when the number of the consecutive ACK equals to 6, the detailed feedback information is the front 6 ACK/NACK information is ACK, and other 3 ACK/NACK information is DTX, that is, “A, A, A, A, A, A, D, D, D”; when the number of the consecutive ACK equals to 9, the detailed feedback information is the 9 ACK/NACK information is ACK.

The number of the consecutive ACK of the feedback information denoted by the 2 bits (N/D, A) can be 2, 5 or 8. When the number of the consecutive ACK equals to 2, the detailed feedback information is the front 2 ACK/NACK information is ACK, and other 7 ACK/NACK information is DTX, that is, “A, A, D, D, D, D, D, D, D”; when the number of the consecutive ACK equals to 5, the detailed feedback information is the front 5 ACK/NACK information is ACK, and other 4 ACK/NACK information is DTX, that is, “A, A, A, A, A, D, D, D, D”; when the number of the consecutive ACK equals to 8, the detailed feedback information is the front 8 ACK/NACK information is ACK and the ninth ACK/NACK information is NACK/DTX.

The number of the consecutive ACK of the feedback information denoted by the 2 bits (A, N/D) can be 1, 4 or 7. When the number of the consecutive ACK equals to 1, the detailed feedback information is the first ACK/NACK information is ACK, and other 8 ACK/NACK information is DTX, that is, “A, D, D, D, D, D, D, D, D”; when the number of the consecutive ACK equals to 4, the detailed feedback information is the front 4 ACK/NACK information is ACK, and other 5 ACK/NACK information is DTX, that is, “A, A, A, A, D, D, D, D, D”; when the number of the consecutive ACK equals to 7, the detailed feedback information is the front 7 ACK/NACK information is ACK and the eight ACK/NACK information is NACK/DTX and the ninth ACK/NACK information can be any one of CK, NACK, DTX.

(N/D, N/D) denotes a residual situation. Specifically, (N/D, N/D) can indicate the first ACK/NACK information is NACK, and the other 8 ACK/NACK information can be any one of ACK, NACK, DTX; or, indicate all the feedback situations that the number of the consecutive ACK equals to 1 except for “A, D, D, D, D, D, D, D, D”; or indicate all the feedback situations that the number of the consecutive ACK equals to 2 except for “A, A, D, D, D, D, D, D, D”; or, indicate all the feedback situations that the number of the consecutive ACK equals to 3 except for “A, A, A, D, D, D, D, D, D”; or, indicate all the feedback situations that the number of the consecutive ACK equals to 4 except for “A, A, A, A, D, D, D, D, D”; or, indicate all the feedback situations that the number of the consecutive ACK equals to 5 except for “A, A, A, A, A, D, D, D, D”; or, indicate all the feedback situations that the number of the consecutive ACK equals to 6 except for “A, A, A, A, A, A, D, D, D”. (D, N/D) can indicate the first ACK/NACK information is DTX, and other 8 ACK/NACK information can be any one of ACK, NACK, DTX.

TABLE 3

| At most 4 ACK/NACK | |
|---|---|
| information in binding | mapping |
| window | status |
| A, A, A, A, A, A, A, | A, A |
| A, A | |
| Or, A, A, A, A, A, A, | |
| D, D, D | |
| Or, A, A, A, D, D, D, | |
| D, D, D | |
| A, A, A, A, A, A, A, | N/D, A |
| A, D/N | |
| Or, A, A, A, A, A, D, | |
| D, D, D | |
| Or, A, A, D, D, D, D, | |
| D, D, D | |
| A, A, A, A, A, A, A, | A, |
| D/N, any | N/D |
| Or, A, A, A, A, D, D, | |
| D, D, D | |
| Or, A, D, D, D, D, D, | |
| D, D, D | |
| N, any, any, any, | N, |
| any, any, any, any, any | N/D |
| Or, A, D/N, any, any, | |
| any, any, any, any, any | |
| except for A, D, D, D, D, | |
| D, D, D, D | |
| Or, A, A, D/N, any, | |
| any, any, any, any, any | |
| except for A, A, D, D, D, | |
| D, D, D, D | |
| Or, A, A, A, D/N, | |
| any, any, any, any, any | |
| except for A, A, A, D, D, | |
| D, D, D, D | |
| Or, A, A, A, A, D/N, | |
| any, any, any, any except | |
| for A, A, A, A, D, D, D, | |
| D, D | |
| Or, A, A, A, A, A, | |
| D/N, any, any, any except | |
| for A, A, A, A, A, D, D, | |
| D, D | |
| Or, A, A, A, A, A, A, | |
| D/N, any, any except for | |
| A, A, A, A, A, A, D, D, D | |
| D, any, any, any, | D, |
| any, any, any, any, any | N/D |

### Second Exemplary Embodiment

In the uplink-Downlink Configuration 5 of the TDD, because one uplink sub-frame is required to feed back ACK/NACK feedback information of at most 9 downlink sub-frames, that is, the binding window size is 9. On the assumption that sue to some limitations, the base station transmits PDCCH or SPS service business data which are needed to feed back ACK/NACK information only through a portion of the sub-frames. For example, the base station can set the maximal number of PDCCH or SPS service business data which are needed to feed back ACK/NACK information in the binding window of the UE through TD-SCDMA RAN; or through other method, the UE can identify the maximal number of PDCCH or SPS service business data which are needed to feed back ACK/NACK information in the binding window. Then, the processes of generating the 4 feedback statuses can be adjusted according to the actual possible maximal number of the ACK/NACK information. It is supposed in the following that the base station can transmit PDCCH or SPS service business data which are needed to feed back ACK/NACK information through at most 5 sub-frames. At this time, 2 bit feedback information of each cell can be generated through the following methods. As shown in table 4,

The 2 bits (A, A) denotes the front 3 ACK/NACK information is ACK, and the forth ACK/NACK information is NACK/DTX, and the fifth ACK/NACK information can be any one of ACK, NACK, DTX.

The number of the consecutive ACK of the feedback information denoted by the 2 bits (N/D, A) can be 2 or 5. When the number of the consecutive ACK equals to 2, the detailed feedback information is the front 2 ACK/NACK information is ACK, and other 3 ACK/NACK information is DTX, that is, “A, A, D, D, D”; when the number of the consecutive ACK equals to 5, the detailed feedback information is all the ACK/NACK information is ACK.

The number of the consecutive ACK of the feedback information denoted by the 2 bits (A, N/D) can be 1 or 4. When the number of the consecutive ACK equals to 1, the detailed feedback information is the first ACK/NACK information is ACK, and other 4 ACK/NACK information is DTX, that is, “A, D, D, D, D”; when the number of the consecutive ACK equals to 4, the detailed feedback information is the front 4 ACK/NACK information is ACK, and the fifth ACK/NACK information is NACK/DTX.

(N/D, N/D) denotes the residual situation. Specifically, (N, N/D) can indicate the first ACK/NACK information is NACK, and other 4 ACK/NACK information can be any one of ACK, NACK, DTX; or, indicate all the feedback situations that the number of the consecutive ACK equals to 1 except for “A, D, D, D, D”; or indicate all the feedback situations that the number of the consecutive ACK equals to 2 except for “A, A, D, D, D”. (D, N/D) can indicate the first ACK/NACK information is DTX, and other 4 ACK/NACK information can be any one of ACK, NACK, DTX.

TABLE 4

| At most 4 ACK/NACK information in | mapping |
|---|---|
| binding window | status |
| A, A, A, D/N, any | A, A |
| A, A, A, A, A | N, A |
| Or, A, A, D, D, D | |
| A, A, A, A, D/N | A, N |
| Or, A, D, D, D, D | |
| N, any, any, any, any | N, N |
| Or, A, D/N, any, any, any except | |
| for A, D, D, D, D | |
| Or, A, A, D/N, any, any except for | |
| A, A, D, D, D | |
| D, any, any, any, any | D, D |

The present disclosure also provides another method of feeding back ACK/HACK information that includes: the UE in the uplink-Downlink Configuration 5 of the TDD receiving PDCCH information and downlink data transmitted by a base station in a Pcell and a Scell, and generating ACK/NACK feedback information corresponding to the Pcell and the Scell; determining a feedback status for each of the Pcell and the Scell from 5 feedback statuses according to the ACK/NACK feedback information of the Pcell and the Scell in a current binding window; and feeding back the feedback information of the Pcell and the Scell by the UE based on channel selection method.

The above mentioned 5 feedback statuses can be:

the feedback is denoted by Fₚ when the number of consecutive ACKs is p;

when p=1, 2, . . . , M−3, each Fₚ can be separated into two subset feedbacks, and M denotes a length of the binding window; the first subset feedback of the two subset feedbacks denotes that the front p ACK/NACK information is ACK; the other M-p ACK/NACK information is DTX, which is denoted by F_{p,DTA}; the second subset feedback of the two subset feedbacks denotes other statuses in the feedback Fₚ except for subset feedback F_{p,DTX} and can be denoted by F_{p,NACK};

the feedback status 0, the feedback status 1 and the feedback status 2 of the 5 feedback statuses are respectively:

$$\begin{matrix}{G}_{3 m + 3} , m = 0 , 1 , 2 , … , ⌊ ( M - 3 ) / 3 ⌋ , & [ Eqn . 5 ] \\ {G}_{3 m + 2} , m = 0 , 1 , 2 , … , ⌊ ( M - 2 ) / 3 ⌋ & [ Eqn . 6 ] \\ {G}_{3 m + 1} , m = 0 , 1 , 2 , … , ⌊ ( M - 1 ) / 3 ⌋ , & [ Eqn . 7 ] \\ wherein {G}_{p} = \{ \begin{matrix}{F}_{p , DTX} , p = 1 , 2 , … , M - 3 \\ {F}_{p} , p = M - 2 , M - 1 , M ;\end{matrix} & [ Eqn . 8 ]\end{matrix}$$

the feedback status 3 of the 5 feedback statuses is F_{p,NACK} and the feedback status 4 is Fₚ.

The manner, in which the UE feeds back the feedback information of the Pcell and the Scell based on channel selection method, are:

1) when the feedback status of the Pcell is the feedback status 4 and the feedback status of the Scell is the feedback status 3 or 4, the UE does not feed back;

2) when the feedback status of the Pcell is the feedback status 3 and the feedback status of the Scell is the feedback status 3 or 4, the UE uses the channel h0, of which the QPSK constellation point is 1, to feed back;

3) when the feedback status of the Pcell is the feedback status 2 and the feedback status of the Scell is the feedback status 3 or 4, the UE uses the channel h0, of which the QPSK constellation point is −1, to feed back;

4) when the feedback status of the Pcell is the feedback status 1 and the feedback status of the Scell is the feedback status 3 or 4, the UE uses the channel h1, of which the QPSK constellation point is −j, to feed back;

5) when the feedback status of the Pcell is the feedback status 0 and the feedback status of the Scell is the feedback status 3 or 4, the UE uses the channel h1, of which the QPSK constellation point is j, to feed back;

6) when the feedback status of the Pcell is the feedback status 3 or 4 and the feedback status of the Scell is the feedback status 2, the UE uses the channel h2, of which the QPSK constellation point is 1, to feed back;

7) when the feedback status of the Pcell is the feedback status 2 and the feedback status of the Scell is the feedback status 2, the UE uses the channel h2, of which the QPSK constellation point is j, to feed back;

8) when the feedback status of the Pcell is the feedback status 1 and the feedback status of the Scell is the feedback status 2, the UE uses the channel h2, of which the QPSK constellation point is −j, to feed back;

9) when the feedback status of the Pcell is the feedback status 0 and the feedback status of the Scell is the feedback status 2, the UE uses the channel h2, of which the QPSK constellation point is −1, to feed back;

10) when the feedback status of the Pcell is the feedback status 3 or 4 and the feedback status of the Scell is the feedback status 1, the UE uses the channel h3, of which the QPSK constellation point is 1, to feed back;

11) when the feedback status of the Pcell is the feedback status 2 and the feedback status of the Scell is the feedback status 1, the UE uses the channel h0, of which the QPSK constellation point is −j, to feed back;

12) when the feedback status of the Pcell is the feedback status 1 and the feedback status of the Scell is the feedback status 1, the UE uses the channel h3, of which the QPSK constellation point is j, to feed back;

13) when the feedback status of the Pcell is the feedback status 0 and the feedback status of the Scell is the feedback status 1, the UE uses the channel h0, of which the QPSK constellation point is j, to feed back;

14) when the feedback status of the Pcell is the feedback status 3 or 4 and the feedback status of the Scell is the feedback status 0, the UE uses the channel h3, of which the QPSK constellation point is −j, to feed back;

15) when the feedback status of the Pcell is feedback status 2 and the feedback status of the Scell is feedback status 0, the UE uses the channel h3, of which the QPSK constellation point is −1, to feed back;

16) when the feedback status of the Pcell is the feedback status 1 and the feedback status of the Scell is the feedback status 0, the UE uses the channel h1, of which the QPSK constellation point is 1, to feed back;

17) when the feedback status of the Pcell is the feedback status 0 and the feedback status of the Scell is the feedback status 0, the UE uses the channel h1, of which the QPSK constellation point is −1, to feed back,

In the above, j and −j are integers.

Further, when the base station transmits PDCCH or SPS service business data which are needed to feed back ACK/NACK information only through a portion of the sub-frames, UE receives the portion of the sub-frames of the PDCCH information transmitted by the base station in the Pcell and the Scell, and generates ACK/NACK feedback information corresponding to the Pcell and the Scell, and determines feedback statuses of the Pcell and the Scell according to the ACK/NACK feedback information.

Specific exemplary embodiments of the present disclosure are described below.

### Third Exemplary Embodiment

In the uplink-downlink configuration 5 of the TDD, because one uplink sub-frame is required to feed back ACK/NACK feedback information of at most 9 downlink sub-frames, that is, the binding window size is 9. At this time, 5 mapping statuses of each cell can be generated through the following methods, as shown in table 5.

The number of the consecutive ACK of the feedback information denoted by the mapping status (A, A) can be 3, 6 or 9. When the number of the consecutive ACK equals to 3, the detailed feedback information is the front 3 ACK/NACK information is ACK, and other 6 ACK/NACK information is DTX, that is, “A, A, A, D, D, D, D, D, D”; when the number of the consecutive ACK equals to 6, the detailed feedback information is the front 6 ACK/NACK information is ACK, and other 3 ACK/NACK information is DTX, that is, “A, A, A, A, A, A, D, D, D”; when the number of the consecutive ACK equals to 9, the detailed feedback information is the 9 ACK/NACK information is ACK.

The number of the consecutive ACK of the feedback information denoted by the mapping status (N/D, A) can be 2, 5 or 8. When the number of the consecutive ACK equals to 2, the detailed feedback information is the front 2 ACK/NACK information is ACK, and other 7 ACK/NACK information is DTX, that is, “A, A, D, D, D, D, D, D, D”; when the number of the consecutive ACK equals to 5, the detailed feedback information is the front 5 ACK/NACK information is ACK, and other 4 ACK/NACK information is DTX, that is, “A, A, A, A, A, D, D, D, D”; when the number of the consecutive ACK equals to 8, the detailed feedback information is the front 8 ACK/NACK information is ACK and the ninth ACK/NACK information is NACK/DTX.

The number of the consecutive ACK of the feedback information denoted by the mapping status (A, N/D) can be 1, 4 or 7. When the number of the consecutive ACK equals to 1, the detailed feedback information is the first ACK/NACK information is ACK, and other 8 ACK/NACK information is DTX, that is, “A, D, D, D, D, D, D, D, D”; when the number of the consecutive ACK equals to 4, the detailed feedback information is the front 4 ACK/NACK information is ACK, and other 5 ACK/NACK information is DTX, that is, “A, A, A, A, D, D, D, D, D”; when the number of the consecutive ACK equals to 7, the detailed feedback information is the front 7 ACK/NACK information is ACK and the eighth ACK/NACK information is NACK/DTX and the ninth ACK/NACK information can be any one of CK, NACK, DTX.

The mapping status (N, N/D) can indicate the first ACK/NACK information is NACK, and other 8 ACK/NACK information can be any one of ACK, NACK, DTX; or, indicate all the feedback situations that the number of the consecutive ACK equals to 1 except for “A, D, D, D, D, D, D, D, D”; or indicate all the feedback situations that the number of the consecutive ACK equals to 2 except for “A, A, D, D, D, D, D, D, D”; or, indicate all the feedback situations that the number of the consecutive ACK equals to 3 except for “A, A, A, D, D, D, D, D, D”; or, indicate all the feedback situations that the number of the consecutive ACK equals to 4 except for “A, A, A, A, D, D, D, D, D”; or, indicate all the feedback situations that the number of the consecutive ACK equals to 5 except for “A, A, A, A, A, D, D, D, D”; or, indicate all the feedback situations that the number of the consecutive ACK equals to 6 except for “A, A, A, A, A, A, D, D, D”.

The mapping status (D, N/D) can indicate the first ACK/NACK information is DTX, and other 8 ACK/NACK information can be any one of ACK, NACK, DTX.

TABLE 5

| ACK/NACK information of one cell | |
|---|---|
| in a binding window which needs | Mapping |
| feedback | status |
| A, A, A, A, A, A, A, A, A | A, A |
| Or, A, A, A, A, A, A, D, D, D | |
| Or, A, A, A, D, D, D, D, D, D | |
| A, A, A, A, A, A, A, A, D/N | N/D, A |
| Or, A, A, A, A, A, D, D, D, D | |
| Or, A, A, D, D, D, D, D, D, D | |
| A, A, A, A, A, A, A, D/N, any | A, N/D |
| Or, A, A, A, A, D, D, D, D, D | |
| Or, A, D, D, D, D, D, D, D, D | |
| N, any, any, any, any, any, any, | N, N/D |
| any, any | |
| Or, A, D/N, any, any, any, any, | |
| any, any, any except for A, D, D, D, | |
| D, D, D, D, D | |
| Or, A, A, D/N, any, any, any, | |
| any, any, any except for A, A, D, D, | |
| D, D, D, D, D | |
| Or, A, A, A, D/N, any, any, any, | |
| any, any except for A, A, A, D, D, D, | |
| D, D, D | |
| Or, A, A, A, A, D/N, any, any, | |
| any, any except for A, A, A, A, D, D, | |
| D, D, D | |
| Or, A, A, A, A, A, D/N, any, | |
| any, any except for A, A, A, A, A, D, | |
| D, D, D | |
| Or, A, A, A, A, A, A, D/N, any, | |
| any except for A, A, A, A, A, A, D, | |
| D, D | |
| D, any, any, any, any, any, any, | D, N/D |
| any, any | |

For facilitating description, the following table can be used:

TABLE 6

| | Mapping |
|---|---|
| | status |
| | corresponding to |
| | ACK/NACK |
| ACK/NACK information of one cell | information of one |
| in a binding window which needs | cell which needs |
| feedback | feedback |
| A, A, A, A, A, A, A, A, A | Mapping |
| Or, A, A, A, A, A, A, D, D, D | status 0 |
| Or, A, A, A, D, D, D, D, D, D | |
| A, A, A, A, A, A, A, A, D/N | Mapping |
| Or, A, A, A, A, A, D, D, D, D | status 1 |
| Or, A, A, D, D, D, D, D, D, D | |
| A, A, A, A, A, A, A, D/N, any | Mapping |
| except for A, A, A, A, D, D, D, | status 2 |
| D, D | |
| or, A, D, D, D, D, D, D, D, D | |
| N, any, any, any, any, any, any, | Mapping |
| any, any | status 3 |
| Or, A, D/N, any, any, any, any, | |
| any, any, any except for A, D, D, D, | |
| D, D, D, D, D | |
| Or A, A, D/N, any, any, any, | |
| any, any, any except for A, A, D, D, | |
| D, D, D, D, D | |
| Or, A, A, A, D/N, any, any, any, | |
| any, any except for A, A, A, D, D, D, | |
| D, D, D | |
| Or, A, A, A, A, D/N, any, any, | |
| any, any except for A, A, A, A, D, D, | |
| D, D, D | |
| Or, A, A, A, A, A, D/N, any, | |
| any, any except for A, A, A, A, A, D, | |
| D, D, D | |
| Or, A, A, A, A, A, A, D/N, any, | |
| any except for A, A, A, A, A, A, D, | |
| D, D | |
| D, any, any, any, any, any, any, | Mapping |
| any, any | status 4 |

According to the table 6, the table 5 can be simplified to be table 7, as shown in following:

TABLE 7

| Mapping status corresponding to | |
|---|---|
| ACK/NACK information of one cell in a | Mapping |
| binding window which needs feedback | status |
| Mapping status 0 | A, A |
| Mapping status 1 | N/D, A |
| Mapping status 2 | A, N/D |
| Mapping status 3 | N, N/D |
| Mapping status 4 | D, N/D |

If one channel resource selection corresponding to 4 bits and a mapping table of QPSK symbols transmitted in the selected channel are given, then, the UE can feed back ACK/NACK information of each cell using control channel format 1b selected by the channel according to the table 7 and the mapping table.

According to the method of the disclosure, using the 4-bit mapping table for LTE-A TTD system shown in FIG. 2 can determine the selected channel and ACK/NACK information of two cells corresponding to QPSK symbols transmitted in the channel when the binding window size is 9, as shown in table 8.

TABLE 8

| Pcell | Scell | | |
|---|---|---|---|
| HARQ-ACK(0), | HARQ-ACK(0), | | |
| HARQ-ACK(1), | HARQ-ACK(1), | ACK/NACK | QPSK |
| . . . | . . . | channel | constellation |
| HARQ-ACK(8) | HARQ-ACK(8) | resource | point |
| feedback status 4 | feedback status | Not transmission | |
| | 3 or | | |
| | feedback status 4 | | |
| feedback status 3 | feedback status | h0 | 1 |
| | 3 or | | |
| | feedback status 4 | | |
| feedback status 2 | feedback status | h0 | −1 |
| | 3 or | | |
| | feedback status 4 | | |
| feedback status 1 | feedback status | h1 | −j |
| | 3 or | | |
| | feedback status 4 | | |
| feedback status 0 | feedback status | h1 | j |
| | 3 or | | |
| | feedback status 4 | | |
| feedback status | feedback status 2 | h2 | 1 |
| 3 or | | | |
| feedback status 4 | | | |
| feedback status 2 | feedback status 2 | h2 | J |
| feedback status 1 | feedback status 2 | h2 | −j |
| feedback status 0 | feedback status 2 | h2 | −1 |
| feedback status | feedback status 1 | h3 | 1 |
| 3 or | | | |
| feedback status 4 | | | |
| feedback status 2 | feedback status 1 | h0 | −j |
| feedback status 1 | feedback status 1 | h3 | j |
| feedback status 0 | feedback status 1 | h0 | j |
| feedback status | feedback status 0 | h3 | −j |
| 3 or | | | |
| feedback status 4 | | | |
| feedback status 2 | feedback status 0 | h3 | −1 |
| feedback status 1 | feedback status 0 | h1 | 1 |
| feedback status 0 | feedback status 0 | h1 | −1 |

The foregoing are only preferred embodiments of the present disclosure and are not for use in limiting the protection scope thereof. All modifications, equivalent replacements or improvements in accordance with the spirit and principles of the present disclosure shall be included in the protection scope of the present disclosure.

FIG. 4 illustrates a structure of a UE according to an exemplary embodiment of the present disclosure.

Referring to FIG. 4, the UE includes a receiver 400, a controller 402 and a transmitter 404. The controller 402 controls the receiver 400 and the transmitter 404. Specifically, the controller 402 controls all operations of the UE, including operation for feeding back the ACK/NACK information according to the exemplary embodiments of the present disclosure.

The receiver 400 and the transmitter 404 perform communication with the BS according to the controls of the controller 402. The receiver 400 receives the PDCCH information from the BS, and receives the downlink data from the BS based on the PDCCH information. And the transmitter 404 transmits the ACK/NACK information to the BS, when the ACK/NACK information corresponding to the downlink data is generated by the controller 402.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for feeding back Acknowledgement/Negative Acknowledgement (ACK/NMK) information by a User Equipment (UE) in a wireless communication system, the method comprising:
receiving Physical Downlink Control Channel (PDCCH) information from a base station (BS), and receiving downlink data from the BS based on the PDCCH information;
generating ACK/NACK feedback information corresponding to the downlink data;
determining a feedback status of the UE from among a plurality of feedback statuses according to a number of consecutive ACKs starting from a first data sub-frame in a binding window of the ACK/NACK feedback information; and
feeding back information on the determined feedback status to the BS.

2. The method of claim 1, wherein the plurality of feedback statuses includes a first feedback status, a second feedback status, a third feedback status and a fourth feedback status.

3. The method of claim 2, wherein a feedback is denoted by Fₚ when the number of consecutive ACKs is p;
when p=1, 2, . . . , M−3 , each Fₚ is separated into two subset feedbacks, wherein M denotes a length of the binding window; a first subset feedback of the two subset feedbacks denotes that front p ACK/NACK information is ACK; other M-p ACK/NACK information is Discontinuous Transmission (DTX), which is denoted by F_{p,DTX}; a second subset feedback of the two subset feedbacks denotes other statuses in the feedback Fₚ except for subset feedback F_{p,DTX} and is denoted by F_{p, NACK};
wherein the first feedback status is a set of the F₀ and F_{p,NACK}, p=1, 2, . . . , M−3;
the second, third and forth feedback statuses are respectively:
$${G}_{3 m + 1} , m = 0 , 1 , 2 , … , ⌊ ( M - 1 ) / 3 ⌋ ;$$
$${G}_{3 m + 2} , m = 0 , 1 , 2 , … , ⌊ ( M - 2 ) / 3 ⌋ ; and$$
$${G}_{3 m + 3} , m = 0 , 1 , 2 , … , ⌊ ( M - 3 ) / 3 ⌋ , \\ wherein , {G}_{p} = \{ \begin{matrix}{F}_{p , DTX} , p = 1 , 2 , … , M - 3 \\ {F}_{p} , p = M - 2 , M - 1 , M .\end{matrix}$$

4. The method of claim 2, wherein the first feedback status is determined by using two bits of status information including NACK/DTX;
the second feedback status is determined by using two bits of status information including ACK and NACK/DTX in turn;
the third feedback status is determined by using two bits of status information including NACK/DTX and ACK in turn; and
the forth feedback status is determined by using two bits of status information including ACK.

5. The method of claim 1, wherein receiving the PDCCH information comprises receiving a portion of sub-frames of the PDCCH information from the BS.

6. A method for feeding back Acknowledgement/Negative Acknowledgement (ACK/NACK) information by a User Equipment (UE) in a wireless communication system, the method comprising:
receiving Physical Downlink Control Channel (PDCCH) information from a base station (BS) in each of a main cell and a sub cell, and receiving downlink data from the BS in each of the main cell and the sub cell;
generating ACK/NACK feedback information corresponding to the main cell and the sub cell;
determining a feedback status for each of the main cell and the sub cell from a plurality of feedback statuses according to the ACK/NACK feedback information of the main cell and the sub cell in a binding window; and
feeding back information on the feedback status for each of the main cell and the sub cell to the BS in each of the main cell and the sub cell.

7. The method of claim 6, wherein the plurality of feedback statuses includes a feedback status 0, a feedback status 1, a feedback status 2, a feedback status 3, and a feedback status 4.

8. The method of claim 7, wherein a feedback is denoted by Fₚ when a number of consecutive ACKs is p;
when p=1, 2, . . . , M−3, each Fₚ is separated into two subset feedbacks, and M denotes a length of the binding window; a first subset feedback of the two subset feedbacks denotes that front p ACK/NACK information is ACK; other M-p ACK/NACK information is DTX, which is denoted by F_{p,DTX}; a second subset feedback of the two subset feedbacks denotes other statuses in the feedback Fₚ except for subset feedback F_{p,DTX} and can be denoted by F_{p,NACK};
wherein the feedback status 0, the feedback status 1 and the feedback status 2 are respectively:
$${G}_{3 m + 3} , m = 0 , 1 , 2 , … , ⌊ ( M - 3 ) / 3 ⌋ , \\ {G}_{3 m + 2} , m = 0 , 1 , 2 , … , ⌊ ( M - 2 ) / 3 ⌋ ; and$$
$${G}_{3 m + 1} , m = 0 , 1 , 2 , … , ⌊ ( M - 1 ) / 3 ⌋ ;$$
$$wherein {G}_{p} = \{ \begin{matrix}{F}_{p , DTX} , p = 1 , 2 , … , M - 3 \\ {F}_{p} , p = M - 2 , M - 1 , M ;\end{matrix}$$
wherein the feedback status 3 is F_{p,NACK}, and the feedback status 4 is Fₚ.

9. The method of claim 7, wherein feeding back the information on the feedback status for each of the main cell and the sub cell based on channel selection method in following manner:
when the feedback status of the main cell is the feedback status 4 and the feedback status of the sub cell is the feedback status 3 or 4, the UE does not feed back;
when the feedback status of the main cell is the feedback status 3 and the feedback status of the sub cell is the feedback status 3 or 4, the UE uses a channel h0, of which a QPSK constellation point is 1, to feed back;
when the feedback status of the main cell is the feedback status 2 and the feedback status of the sub cell is the feedback status 3 or 4, the UE uses the channel h0, of which a QPSK constellation point is −1, to feed back;
when the feedback status of the main cell is the feedback status 1 and the feedback status of the sub cell is the feedback status 3 or 4, the UE uses a channel h1, of which a QPSK constellation point is −j, to feed back;
when the feedback status of the main cell is the feedback status 0 and the feedback status of the sub cell is the feedback status 3 or 4, the UE uses the channel h1, of which a QPSK constellation point is j, to feed back;
when the feedback status of the main cell is the feedback status 3 or 4 and the feedback status of the sub cell is the feedback status 2, the UE uses a channel h2, of which a QPSK constellation point is 1, to feed back;
when the feedback status of the main cell is the feedback status 2 and the feedback status of the sub cell is the feedback status 2, the UE uses the channel h2, of which a QPSK constellation point is j, to feed back;
when the feedback status of the main cell is the feedback status 1 and the feedback status of the sub cell is the feedback status 2, the UE uses the channel h2, of which a QPSK constellation point is −j, to feed back;
when the feedback status of the main cell is the feedback status 0 and the feedback status of the sub cell is the feedback status 2, the UE uses the channel h2, of which a QPSK constellation point is −1, to feed back;
when the feedback status of the main cell is the feedback status 3 or 4 and the feedback status of the sub cell is the feedback status 1, the UE uses a channel h3, of which a QPSK constellation point is 1, to feed back;
when the feedback status of the main cell is the feedback status 2 and the feedback status of the sub cell is the feedback status 1, the UE uses the channel h0, of which a QPSK constellation point is −j, to feed back;
when the feedback status of the main cell is the feedback status 1 and the feedback status of the sub cell is the feedback status 1, the UE uses the channel h3, of which a QPSK constellation point is j, to feed back;
when the feedback status of the main cell is the feedback status 0 and the feedback status of the sub cell is the feedback status 1, the UE uses the channel h0, of which a QPSK constellation point is j, to feed back;
when the feedback status of the main cell is the feedback status 3 or 4 and the feedback status of the sub cell is the feedback status 0, the UE uses the channel h3, of which a QPSK constellation point is −j, to feed back;
when the feedback status of the main cell is the feedback status 2 and the feedback status of the sub cell is the feedback status 0, the UE uses the channel h3, of which a QPSK constellation point is −1, to feed back;
when the feedback status of the main cell is the feedback status 1 and the feedback status of the sub cell is the feedback status 0, the UE uses the channel h1, of which a QPSK constellation point is 1, to feed back; and
when the feedback status of the main cell is the feedback status 0 and the feedback status of the sub cell is the feedback status 0, the UE uses the channel h1, of which a QPSK constellation point is −1, to feed back,
wherein j and −j are integers.

10. The method of claim 6, wherein receiving the PDCCH information comprises receiving a portion of sub-frames of the PDCCH information from the BS in each of the main cell and the sub cell.

11. A User Equipment (UE) for feeding back Acknowledgement/Negative Acknowledgement (ACK/NACK) information in a wireless communication system, the UE comprising:
a receiver configured to receive Physical Downlink Control Channel (PDCCH) information from a base station (BS), and receive downlink data from the BS based on the PDCCH information;
a controller configured to generate ACK/NACK feedback information corresponding to the downlink data, and determine a feedback status of the UE from among plurality of feedback statuses, according to a number of consecutive ACKs starting from a first data sub-frame in a binding window of the ACK/NACK feedback information; and
a transmitter configured to feed back information on the determined feedback status to the BS.

12. The UE of claim 11, wherein the plurality of feedback statuses includes a first feedback status, a second feedback status, a third feedback status and a fourth feedback status.

13. The UE of claim 12, wherein a feedback is denoted by Fₚ when the number of consecutive ACKs is p;
when p==1,2, . . . , M−3, each Fₚ is separated into two subset feedbacks, wherein M denotes a length of the binding window; a first subset feedback of the two subset feedbacks denotes that front p ACK/NACK information is ACK; other M-p ACK/NACK information is Discontinuous Transmission (DTX), which is denoted by F_{p,DTX} ; a second subset feedback of the two subset feedbacks denotes other statuses in the feedback Fₚ except for subset feedback F_{p,DTX} and is denoted by F_{p,NACK};
wherein the first feedback status is a set of the F₀ and F_{p,NACK}, p=1, 2, . . . , M−3;
the second, third and forth feedback statuses are respectively:
$${G}_{3 m + 1} , m = 0 , 1 , 2 , … , ⌊ ( M - 1 ) / 3 ⌋ ;$$
$${G}_{3 m + 2} , m = 0 , 1 , 2 , … , ⌊ ( M - 2 ) / 3 ⌋ ; and$$
$${G}_{3 m + 3} , m = 0 , 1 , 2 , … , ⌊ ( M - 3 ) / 3 ⌋ , \\ wherein , {G}_{p} = \{ \begin{matrix}{F}_{p , DTX} , p = 1 , 2 , … , M - 3 \\ {F}_{p} , p = M - 2 , M - 1 , M .\end{matrix}$$

14. The UE of claim 12, wherein
the first feedback status is determined by using two bits of status information including NACK/DTX;
the second feedback status is determined by using two bits of status information including ACK and NACK/DTX in turn;
the third feedback status is determined by using two bits of status information including NACK/DTX and ACK in turn; and
the forth feedback status is determined by using two bits of status information including ACK.

15. The UE of claim 11, wherein the receiver is configured to receive a portion of sub-frames of the PDCCH information from the BS.

16. A User Equipment (UE) for feeding back Acknowledgement/Negative Acknowledgement (ACK/NACK) information in a wireless communication system, the UE comprising:
a receiver configured to receive Physical Downlink Control Channel (PDCCH) information from a base station (BS) in each of a main cell and a sub cell, and receive downlink data from the BS in each of the main cell and the sub cell;
a controller configured to generate ACK/NACK feedback information corresponding to the main cell and the sub cell, and determining a feedback status for each of the main cell and the sub cell from a plurality of feedback statuses according to the ACK/NACK feedback information of the main cell and the sub cell in a binding window; and
a transmitter configured to feed back information on the feedback status for each of the main cell and the sub cell to the BS in each of the main cell and the sub cell.

17. The UE of claim 16, wherein the plurality of feedback statuses includes a feedback status 0, a feedback status 1, a feedback status 2, a feedback status 3, and a feedback status 4.

18. The UE of claim 17, wherein a feedback is denoted by Fₚ when a number of consecutive ACKs is p;
when p=1,2, . . . , M−3, each Fₚ is separated into two subset feedbacks, and M denotes a length of the binding window; a first subset feedback of the two subset feedbacks denotes that front p ACK/HACK information is ACK; other M-p ACK/NACK information is DTX, which is denoted by F_{p,DTX}; a second subset feedback of the two subset feedbacks denotes other statuses in the feedback Fₚ except for subset feedback F_{p,DTX} and can be denoted by F_{p,NACK};
wherein the feedback status 0, the feedback status 1 and the feedback status 2 are respectively:
$${G}_{3 m + 3} , m = 0 , 1 , 2 , … , ⌊ ( M - 3 ) / 3 ⌋ , \\ {G}_{3 m + 2} , m = 0 , 1 , 2 , … , ⌊ ( M - 2 ) / 3 ⌋ ; and$$
$${G}_{3 m + 1} , m = 0 , 1 , 2 , … , ⌊ ( M - 1 ) / 3 ⌋ , wherein$$
$${G}_{p} = \{ \begin{matrix}{F}_{p , DTX} , p = 1 , 2 , … , M - 3 \\ {F}_{p} , p = M - 2 , M - 1 , M ;\end{matrix}$$
wherein the feedback status 3 is F_{p,NACK} and the feedback status 4 is Fₚ.

19. The UE of claim 16, wherein the transmitter is configured to feed back the information on the feedback status for each of the main cell and the sub cell based on channel selection method in following manner:
when the feedback status of the main cell is the feedback status 4 and the feedback status of the sub cell is the feedback status 3 or 4, the UE does not feed back;
when the feedback status of the main cell is the feedback status 3 and the feedback status of the sub cell is the feedback status 3 or 4, the UE uses a channel h0, of which a QPSK constellation point is 1, to feed back;
when the feedback status of the main cell is the feedback status 2 and the feedback status of the sub cell is the feedback status 3 or 4, the UE uses the channel h0, of which a QPSK constellation point is −1, to feed back;
when the feedback status of the main cell is the feedback status 1 and the feedback status of the sub cell is the feedback status 3 or 4, the UE uses a channel h1, of which a QPSK constellation point is −j, to feed back;
when the feedback status of the main cell is the feedback status 0 and the feedback status of the sub cell is the feedback status 3 or 4, the UE uses the channel h1, of which a QPSK constellation point is j, to feed back;
when the feedback status of the main cell is the feedback status 3 or 4 and the feedback status of the sub cell is the feedback status 2, the UE uses a channel h2, of which a QPSK constellation point is 1, to feed back;
when the feedback status of the main cell is the feedback status 2 and the feedback status of the sub cell is the feedback status 2, the UE uses the channel h2, of which a QPSK constellation point is j, to feed back;
when the feedback status of the main cell is the feedback status 1 and the feedback status of the sub cell is the feedback status 2, the UE uses the channel h2, of which a QPSK constellation point is −j, to feed back;
when the feedback status of the main cell is the feedback status 0 and the feedback status of the sub cell is the feedback status 2, the UE uses the channel h2, of which a QPSK constellation point is −1, to feed back;
when the feedback status of the main cell is the feedback status 3 or 4 and the feedback status of the sub cell is the feedback status 1, the UE uses a channel h3, of which a QPSK constellation point is 1, to feed back;
when the feedback status of the main cell is the feedback status 2 and the feedback status of the sub cell is the feedback status 1, the UE uses the channel h0, of which a QPSK constellation point is −j, to feed back;
when the feedback status of the main cell is the feedback status 1 and the feedback status of the sub cell is the feedback status 1, the UE uses the channel h3, of which a QPSK constellation point is j, to feed back;
when the feedback status of the main cell is the feedback status 0 and the feedback status of the sub cell is the feedback status 1, the UE uses the channel h0, of which a QPSK constellation point is j, to feed back;
when the feedback status of the main cell is the feedback status 3 or 4 and the feedback status of the sub cell is the feedback status 0, the UE uses the channel h3, of which a QPSK constellation point is −j, to feed back;
when the feedback status of the main cell is the feedback status 2 and the feedback status of the sub cell is the feedback status 0, the UE uses the channel h3, of which a QPSK constellation point is −1, to feed back;
when the feedback status of the main cell is the feedback status 1 and the feedback status of the sub cell is the feedback status 0, the UE uses the channel h1, of which a QPSK constellation point is 1, to feed back;
when the feedback status of the main cell is the feedback status 0 and the feedback status of the sub cell is the feedback status 0, the UE uses the channel h1, of which a QPSK constellation point is −1, to feed back,
where j and −j are integers.

20. The UE of claim 16, wherein the receiver is configured to receive a portion of sub-frames of the PDCCH information from the BS in each of the main cell and the sub cell.
